(19) United States
(12) Patent Application Publication
(10) Pub. No.: US 2025/0260006 A1
(43) Pub. Date: Aug. 14, 2025

(54) PRE-LITHIATED LITHIUM METAL OXIDE LITHIUM ION BATTERIES WITH Si-CONTAINING ANODE

(71) Applicant: Pacific Industrial Development Corporation, Ann Arbor, MI (US)

(72) Inventors: Bing Tan, Ann Arbor, MI (US); Yuhao Liao, Ann Arbor, MI (US); Andrew Rajewski, Clinton, MI (US); Wei Wu, Ann Arbor, MI (US)

(21) Appl. No.: 18/702,405

(22) PCT Filed: Oct. 12, 2022
(86) PCT No.: PCT/US2022/046362

§ 371 Date: Apr. 18, 2024

Related U.S. Application Data
(60) Provisional application No. 63/275,066, filed on Nov. 3, 2021.

(51) Int. Cl. H01M 4/505; H01M 4/02; H01M 4/36; H01M 4/48; H01M 4/587; H01M 10/0525; H01M 10/0565

(52) U.S. Cl. CPC H01M 4/505; H01M 4/364; H01M 4/48; H01M 4/587; H01M 10/0525; H01M 10/0565; H01M 2004/021; H01M 2300/0085

(57) ABSTRACT

A cell for use in an electrochemical cell having positive and negative electrodes. The positive electrode includes a current collector and a pre-lithiated active cathode material formed of one or more of Li₁₊ₓMn₂O₄, Li₁₊ₓNi_{0.5}Mn_{1.5}O₄, Li₁₊ₓNiO₂, Li₁₊ₓCoO₂, Li₁₊ₓNiₐCo_{b}Mn_{c}AlO₂, wherein x is in the range of 0.1 to 1.0; a+b+c+d=1; a≥0.5; 0<b≤0.3; 0≤c≤0.3; and 0≤d≤0.05. The negative electrode includes a current collector and an active anode material that is a mixture of at least carbon and a silicon material. The silicon material is silicon metal, SiO_{y}, or a mixture or composite thereof with y ranging between 0≤y<2. The carbon is graphite, soft carbon, or hard carbon. The cell has a positive electrode exhibiting a 1st cycle Coulombic efficiency (CE_{cathode}) and a negative electrode exhibiting a 1^{st} cycle Coulombic Efficiency (CE_{anode}), such that CE_{cathode}<CE_{anode}.

### CROSS-REFERENCE TO RELATED APPLICATIONS

This application claims the benefit of the filing date under 35 U.S.C. § 119 (e) of U.S. Provisional Application No. 63/275,066 filed Nov. 3, 2021, the entire contents of which is hereby incorporated herein by reference.

### FIELD

This invention generally relates to rechargeable batteries. More specifically, the present disclosure describes an electrochemical cell that may be used in a rechargeable battery.

### BACKGROUND

The statements in this section merely provide background information related to the present disclosure and may not constitute prior art.

Electric vehicles (EV) are becoming the generation of vehicles that may replace vehicles powered with an Internal Combustion Engine (ICE). The main component in an electric vehicle (EV) is its battery. This battery accounts for a significant proportion of the cost, mileage, and safety exhibited by the vehicle. In order to provide the necessary amount of energy, the battery used in an EV generally comprises multiple cells. In many cases, the number of cells used in a battery may range up to hundreds of cells or even thousands of cells. In order to extend the distance or mileage that the vehicle may travel prior to requiring recharging and to increase the overall safety of the vehicle, it is necessary to enhance the energy density and the safety of the battery at the individual cell level.

The conventional lithium ion cell used in an EV application incorporates an anode (e.g., graphite, etc.) a cathode (e.g., lithium metal oxide/phosphate, etc.) and an organic electrolyte containing LiPF₆. One issue with conventional cells is that they may cause a fire during a thermal runaway situation, mainly resulting from the interaction between the organic electrolyte and the graphite anode. In addition, since the active graphite material used in the anode exhibits a limited amount of specific capacity (i.e., theoretical=372 mAh/g), the energy density of the cell becomes restricted. In order to improve overall safety and increase the energy density, the battery industry has been interested in the development of lithium metal cells that use non-flammable electrolytes, including solid-state electrolytes. However, there are many challenges associated with the commercialization of this type of cell.

In order to increase the energy density, silicon may be used alone or blended with graphite. Cells, such as those in the Tesla 21700 battery, are commercially available that contain a low percentage of silicon (i.e., <10 wt. % vs. graphite) in the anode. A further increase of silicon (Si) metal or silicon oxides has not been achieved in commercial cells for multiple reasons. One reason centers around the 1^{st} Coulombic Efficiency (CE_{anode}) for the anode material containing graphite and silicon or a silicon oxide is <80%, which is much lower than the 1^{st} CE_{cathode} for the cathode material (i.e., >92%). Another reason is that the cell cycling lifetime with a decent or large amount of silicon (e.g., ≥10 wt. %) is relatively poor without pre-lithiating the anode. However, the processes available for pre-lithiation of anode materials are not cost-effective because the pre-lithiated materials become brittle and sensitive to moisture and oxygen in air. Thus, a low-cost pre-lithiation process is desirable for manufacturing an active anode material containing a decent or large amount of silicon (e.g., ≥10 wt. %).

### SUMMARY

This disclosure generally provides an electrochemical cell that may be used in a rechargeable battery. This rechargeable electrochemical cell comprises a positive electrode and a negative electrode. The positive electrode includes a current collector and a pre-lithiated active cathode material that comprises one or more of Li₁₊ₓMn₂O₄, Li₁₊ₓNi_{0.5}Mn_{1.5}O₄, Li₁₊ₓNiO₂, Li₁₊ₓCoO₂, Li₁₊ₓNiₐCo_{b}Mn_{c}Al_{d}O₂, wherein x is in the range of 0.1 to 1.0; a+b+c+d=1; a≥0.5; 0≤b≤0.3; 0≤c≤0.3; and 0≤d≤0.05. The negative electrode includes a current collector and an active anode material that comprises a mixture of at least carbon and a silicon material; wherein the silicon material is silicon metal, SiO_{y}, or a mixture or composite thereof; wherein y ranges between 0≤y<2 and the carbon is graphite, soft carbon, or hard carbon. The positive electrode has a 1^{st} cycle Coulombic efficiency (CE_{cathode}) and the negative electrode has a 1^{st} cycle Coulombic Efficiency (CE_{anode}), such that CE_{cathode}<CE_{anode}. When desirable, for the pre-lithiated active cathode material x may range from 0.3 to 0.6.

The positive electrode may further comprise an additional active cathode material, such that the mixture has a mass ratio of the pre-lithiated active cathode material to the additional active cathode material that ranges from 99.9:0.1 to about 1:99; alternatively, from 99.9:0.1 to about 51:49.

The active anode material may have a mass ratio of silicon material to carbon that is in the range of about 10:90 to about 99.9:0.1; alternatively, in the range of about 20:80 to about 40:60. The silicon material may have an average particle size <1 micrometer (μm); alternatively, between 1 μm and 4 μm; alternatively, >4 μm. The carbon in the active anode material may be graphite.

The cell may further comprise an electrolyte. This electrolyte may be a non-flammable organic electrolyte, a polymeric or gel electrolyte, an inorganic electrolyte, or a combination thereof. Alternatively, the electrolyte is a non-flammable gel electrolyte.

The cell may have an areal reversible cathode capacity loading ≥3.0 mAh/cm²; alternatively, the areal reversible cathode capacity loading is ≥4.5 mAh/cm². In addition, the CE_{cathode} may be less than the CE_{anode} by at least 1.0% up to 10%; alternatively, the CE_{cathode} is less than the CE_{anode} by 10% or more.

The cell may be configured to reach its maximum cell voltage in two or more formation cycles with the cell voltage increasing after each formation cycle. Alternatively, the cell is configured to reach its maximum cell voltage in two or more formation cycles with the cell voltage increasing after at least one formation cycle.

According to another aspect of the present disclosure, a battery pack for use in an electric vehicle is provided. This battery pack generally comprises a plurality of cells as described above and as further defined herein. This plurality of cells may be placed in series or in a parallel configuration in order to increase overall capacity.

According to yet another aspect of the present disclosure, a rechargeable electrochemical cell is provided. This cell generally comprises a positive electrode and a negative electrode. The positive electrode that includes a current collector, and a pre lithiated active cathode material according to the formula F-1 of Li₁₊ₓMn₂O₄, wherein x is in the range of 0.1 to 1.0. The negative electrode includes a current collector and an active anode material that comprises a mixture of at least graphite and a silicon material; wherein the silicon material is silicon metal, SiO_{y}, or a mixture or composite thereof with y ranging between 0≤y<2. The active anode material has a mass ratio of silicon material to graphite that is in the range of about 10:90 to about 99.9:0.1. The positive electrode has a 1^{st} cycle Coulombic efficiency (CE_{cathode}) and the negative electrode has a 1^{st} cycle Coulombic Efficiency (CE_{anode}), such that CE_{cathode}<CE_{anode} by an amount that falls in the range of one of the following groups: i) at least 1.0%, ii) up to 10%, or iii) 10% or more. The cell has an areal reversible cathode capacity loading ≥3.0 mAh/cm². The cell is configured to reach its maximum cell voltage in two or more formation cycles with the cell voltage increasing after each formation cycle or after at least one formation cycle. The positive electrode in this cell may further comprise an additional active cathode material, such that the mixture has a mass ratio of the pre-lithiated active cathode material to the additional active cathode material that ranges from 99.9:0.1 to about 1:99. The silicon material in this cell has an average particle size that is in the range of one of the following groups: i) <1 micrometer (μm), ii) between 1 μm and 4 μm, or iii) >4 μm.

This cell may further include an electrolyte. This electrolyte may be a non-flammable organic electrolyte, a polymeric or gel electrolyte, an inorganic electrolyte, or a combination thereof.

Further areas of applicability will become apparent from the description provided herein. It should be understood that the description and specific examples are intended for purposes of illustration only and are not intended to limit the scope of the present disclosure.

### DESCRIPTION OF THE DRAWINGS

In order that the disclosure may be well understood, there will now be described various forms thereof, given by way of example, reference being made to the accompanying drawings. The components in each of the drawings may not necessarily be drawn to scale, but rather emphasis is placed upon illustrating the principles of the invention.

FIG. 1 is a schematic representation of an electrochemical cell comprising an anode, a cathode, an electrolyte, and a separator according to the teachings of the present disclosure; and

FIG. 2 is a table providing calculations of the properties of an electrode having an active anode material, an electrode having an active cathode material, and a full cell.

The drawings described herein are for illustration purposes only and are not intended to limit the scope of the present disclosure in any way. It should be understood that throughout the description and drawings, corresponding reference numerals indicate like or corresponding parts and features.

### DETAILED DESCRIPTION

The following description is merely exemplary in nature and is in no way intended to limit the present disclosure or its application or uses. For example, the electrochemical cell prepared and used according to the teachings contained herein are described throughout the present disclosure as a battery cell for use in an electric vehicle (EV) in order to more fully illustrate the structural elements and the use thereof. The incorporation and use of such an electrochemical cell in other applications, including without limitation as a cell in another rechargeable battery, such as a “secondary cell” lithium battery, is contemplated to be within the scope of the present disclosure.

As used herein a “battery cell” or “cell” refers to the basic electrochemical unit of a battery that contains the electrodes, separator, and electrolyte. In comparison, a “battery” or “battery pack” refers to a collection of cell(s), e.g., one or more cells, and includes a housing, electrical connections, and possibly electronics for control and protection.

For the purpose of this disclosure, the terms “about” and “substantially” are used herein with respect to measurable values and ranges due to expected variations known to those skilled in the art (e.g., limitations and variability in measurements).

For the purpose of this disclosure, the terms “at least one” and “one or more of” an element are used interchangeably and may have the same meaning. These terms, which refer to the inclusion of a single element or a plurality of the elements, may also be represented by the suffix “(s)” at the end of the element. For example, “at least one metal”, “one or more metals”, and “metal(s)” may be used interchangeably and are intended to have the same meaning.

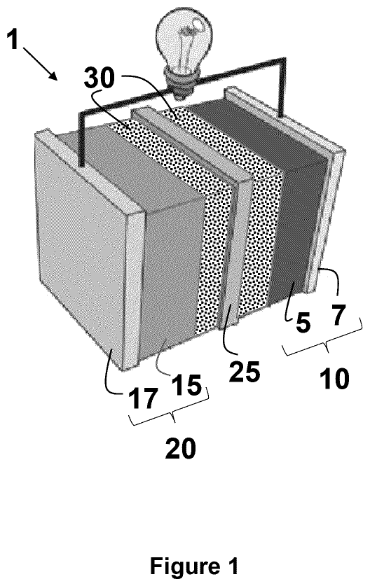

The present disclosure generally provides the use of a pre-lithiated cathode active material in a rechargeable cell, such as a second cell for a lithium-ion battery. Referring to FIG. 1, the electrochemical cell generally comprises a positive electrode 10 and a negative electrode 20. The positive electrode 10 includes an active material (cathode) 5 and a current collector 7, while the negative electrode 20 comprises an active material (anode) 15 and a current collector 17. In addition, the cell includes a non-aqueous electrolyte 30 containing lithium ions and a separator 25. All of these components are sealed in a case, an enclosure, a pouch, a bag, a cylindrical shell, or the like (generally called the battery's “housing”). The separator 25 electrically insulates the cathode 5 from the anode 15, while still allowing lithium ions to flow between them. The flow of ions may be conducted by the separator (i.e., via a solid-state mechanism) or by the presence of a liquid electrolyte 30 that permeates through the porosity of the separator 25 (e.g., a membrane).

Still referring to FIG. 1, the active cathode material 5 is a pre-lithiated material comprising one or more of Li₁₊ₓMn₂O₄, Li₁₊ₓNi_{0.5}Mn_{1.5}O₄, Li₁₊ₓNiO₂, Li₁₊ₓCoO₂, Li₁₊ₓNiₐCo_{b}Mn_{c}Al_{d}O₂, Li₁₊ₓFePO₄, Li₁₊ₓFeₑMn_{f}PO₄, wherein x is in the range of 0.1 to 1.0; a+b+c+d=1; a≥0.5; 0≤b≤0.3; 0≤c≤0.3; 0≤d≤0.05, and e+f=1.0 with e<f. The active anode material 15 comprises a mixture of at least graphite and a silicon material, wherein the silicon material is silicon metal, SiO_{y}, or a mixture or composite thereof; wherein y ranges between 0≤y<2. The positive electrode has a 1^{st} cycle Coulombic Efficiency (CE_{cathode}) and the negative electrode has a 1^{st} cycle Coulombic Efficiency (CE_{anode}), such that CE_{cathode}<CE_{anode}.

As used herein, Coulombic Efficiency (CE) is defined as the ratio of the discharge capacity (mAh/g) to the charge capacity (mAh/g). For each electrode (i.e., positive 10 or negative electrode 20), the CE is generally less than 100%, in particular, for the 1^{st} charge/discharge cycle because of irreversible capacity loss that occurs due to the occurrence of side reactions. For example, on the anode-side of the electrochemical cell (i.e., negative electrode 20), the organic electrolyte 30 may decompose at the low potential range and form a Solid Electrolyte Interface (SEI) film at the surface of the active anode material 15 (i.e., graphite or silicon particles), which consumes capacity irreversibly. On the cathode-side of the electrochemical cell (i.e., positive electrode 10), the electrolyte 30 decomposition at the surface of the active cathode material 5 also occurs, but at a lower level than the decomposition that occurs on the graphite/silicon active anode material 15. This decomposition may also result in the formation of an irreversible crystalline change.

A conventional negative electrode containing graphite as the active anode material generally exhibits a Coulombic Efficiency (CE_{anode}) of about 95% at the 1^{st} cycle. However, the addition of silicon to the graphite in the negative electrode in order to increase the energy density of the cell and reduces the Coulombic Efficiency (CE_{anode}) to 90% or less. In comparison, a conventional positive electrode that contains an active cathode material, such LiNi_{0.8}Co_{0.1}Mn_{0.1}O₂ (NCM-811), exhibits a Coulombic Efficiency (CE_{cathode}) of about 92% at the 1^{st} cycle. Thus, the use of a graphite/silicon active anode material with a conventional positive electrode provides a cell in which the CE_{anode}<CE_{cathode}.

According to the present disclosure, a pre-lithiated cathode active material 5 is used in the electrochemical cell 1 in order to provide the lithium ions that are needed during the 1^{st} charging process of the full cell. The 1^{st} Coulombic Efficiency (CE_{cathode}) of a positive electrode 10 containing this pre-lithiated cathode active material 5 is less than the 1^{st} Coulombic Efficiency (CE_{anode}) of the negative electrode 20 that includes the graphite/silicon anode active material 15. A modified charging protocol may be used when the CE difference between the positive and negative electrodes 10, 20 is large enough to enable a situation wherein the 1^{st} cathode charging capacity becomes larger than the 1^{st} anode charging capacity.

Still referring to FIG. 1, the pre-lithiated cathode active material 5 of the present disclosure represents a material that is active in electron/lithium ions storage and release during charge/discharge cycling similar to a conventional cathode active material, but releases more electrons and more lithium ions in the 1^{st} charging step than the amount of electrons and lithium ions taken in during the 1^{st} discharging step. The excess amount of electrons and lithium ions released from the positive electrode 10 during this first charging step are absorbed by the anode active material 15 in order to compensate for the 1^{st} cycle capacity loss encountered at the negative electrode 20.

According to another aspect of the present disclosure, in order to reduce the 1^{st} Coulombic Efficiency of the cathode, a pre-lithiated cathode active material or a blending of a pre-lithiated cathode active material with a another cathode active material is utilized in the positive electrode. The amount of lithium in the prelithiated cathode active material is configured by controlling the lithium content introduced during the pre-lithiation step, such that the 1^{st} Coulombic Efficiency, CE_{cathode} is ≤90%; alternatively, ≤80%; or alternatively, ≤70%. Several examples of such conventional active cathode materials that may be subjected to a pre-lithiation step include, without limitation, pristine LiMn₂O₄, LiNi_{0.5}Mn_{1.5}O₄, LiNiO₂, LiCoO₂, LiNiₐCo_{b}Mn_{c}Al_{d}O₂, x is in the range of 0.1 to 1.0; a+b+c+d=1; a≥0.5; 0≤b≤0.3; 0≤c≤0.3; and 0≤d≤0.05. The pre-lithiated lithium metal oxide may be used alone or in combination with another cathode active material in a mass ratio of the pre-lithiated active cathode material to the other, e.g., conventional, cathode active material that ranges from about 99:9:0.1 to about 10:90 depending on the application requirements. Alternatively, the mass ratio for the pre-lithiated active cathode material to the conventional or other active cathode material is 99.9:0.1 to 1:99; alternatively, between about 95:5 and about 10:90; alternatively, in the range of about 90:10 to about 20:80; alternatively, in the range of about 80:20 to about 30:70; alternatively, 70:30 to 40:60; alternatively, about 60:40 to about 50:50; alternatively from greater than 99.9:0.1 and to about 51:49.

Still referring to FIG. 1, the active cathode material 5 of the positive electrode 10, generally comprises a pre-lithiated material comprising the chemical formula shown in F-1,

Li₁₊ₓMn₂O₄, (F-1)

wherein x is within the range of 0.1≤x≤1.0; alternatively in the range of 0.3≤x≤0.6. The LiMn₂O₄ that is commercially available is generally formed to have a slight excess of lithium, typically up to 5% and always significantly less than 10% in order to compensate for the amount of lithium lost during the production process. In order for a pre-lithiated active cathode material 5 to be used in the cell 1 of the present disclosure the amount of excess lithium needs to be at least 10% or more. Only in this situation is an amount of excess lithium available for the anode that will improve or enhance the cycle life-time associated with the cell 1. This means that the amount of excess lithium in commercially available LiMn₂O₄ must be increased, e.g., such that x≥0.1 in formula F-1.

In addition to using a pre-lithiated active material according to formula F-1 (Li₁₊ₓMn₂O₄), other pre-lithiated lithium metal oxide materials may also be used either alone or in combination with the material of formula F-1 in the electrochemical cell without exceeding the scope of the present disclosure. These other pre-lithiated lithium metal oxide materials may include, but not be limited to, Li₁₊ₓNi_{0.5}Mn_{1.5}O₄, Li₁₊ₓNiO₂, Li₁₊ₓCoO₂, Li₁₊ₓNiₐCo_{b}Mn_{c}Al_{d}O₂, wherein x is in the range of 0.1 to 1.0; a+b+c+d=1; a≥0.5; 0≤ b≤0.3; 0≤c≤0.3; and 0≤d≤0.05.

The pre-lithiated active material may also include one or more carbon additives. These carbon additives can be selected from carbon nanotubes, graphene, graphite, carbon black, and any conductive carbon. The cell having a positive electrode 10 formed from the prelithiated active material 5 should have an areal reversible cathode capacity that is ≥3.0 mAh/cm²; alternatively, ≥4.5 mAh/cm².

The incorporation of between 10% to 100% of an excess amount of lithium in the pre-lithiated active cathode material 5 changes the crystal structure of the LiMn₂O₄ from spinel to tetragonal, which can be converted back to spinel during cycling. If the lithium content in the pre-lithiated active cathode material 5 is too high (i.e., x>1.0 in formula F-1), a non-tetragonal crystal phase will be formed that cannot be easily converted back to a spinel crystal phase during charging and the reversible capacity of the cell 1 will be reduced.

The preparation of the pre-lithiated active cathode material 5 may be performed in solution by exposing a commercially available compound, such as without limitation LiMn₂O₄, to a relatively mild reducing reagent. This reducing reagent may include, without limitation butyllithium (e.g., n-BuLi, tert-BuLi), lithium naphthalene, or lithium iodide. Butyllithium is known to be very reactive when exposed to air and may pose a fire risk. In order to reduce the risk of creating a fire, the use of a more mild reducing reagent, e.g., lithium naphthalene or the like, is preferable for use in the pre-lithiation of the active cathode material. An organic solution of lithium naphthalene does not generate a significant amount of heat nor pose a fire risk when exposed to air, which makes the production process for the pre-lithiated active cathode material more economical than a process that uses butyllithium. Thus, the present disclosure makes the availability and use of a pre-lithiated cathode active material-comprised cathode having a 1^{st} CE that is lower than that of the anode practical due to the economical feasibility (e.g., low cost) of the production process.

Still referring to FIG. 1, the anode active material 15 in the electrochemical cell 1 is generally, a silicon-containing material. This active anode material 15 may be selected from a range of silicon materials blended or mixed with carbon in the form of graphite, soft carbon, and/or hard carbon. Alternatively, the carbon is graphite. The silicon material is selected from, but not limited to, silicon (Si) metal, silicon oxides (SiO_{y}), or a combination thereof or a Si/SiO_{y} composite formed therefrom. Several specific examples, include without limitation, Si nanoparticles, Si microparticles, SiO_{y} nanoparticles, SiO_{y} microparticles, and/or an Si/SiO_{y} composite particles. The silicon material may exhibit an average particle size (D₅₀) that is <1 micrometer (μm); alternatively between 0.1 μm to 1 μm; alternatively, between 1 μm and 4 μm; alternatively, >4 μm; alternatively, between 4 μm and 50 μm.

The energy density advantage from using a pure silicon (Si) metal active anode material to form the negative electrode is questionable because of the large volume expansion that occurs during cycling and the high delithiation potential associated with the pure silicon active anode material. Thus, according to the present disclosure, the active anode material is a mixture or blend of a silicon material with carbon in a silicon/carbon mass ratio that is in the range of 10/90 to less than 99.9/0.1; alternatively, 15:85 to 80:20; alternatively, 20:80 to 40:60 to ensure energy density improvement and good cycling lifetime.

Silicon exhibits a large volume change during the charging and discharging steps that occur during the operation of an electrochemical cell. During the 1^{st} charging step, silicon particles become much larger, e.g., up to 400% of their original size. When these silicon particles expand, new surfaces are generated that may result in the formation of Solid Electrolyte Interface (SEI) films due to the decomposition of the electrolyte. As a result, the 1^{st} CE of a pure silicon electrode may be as low as about 60%. At this low of a 1^{st} CE, part of the cathode material will not be used reversibly, which reduces the overall energy density of the cell. In order to fully utilize both the anode active material and cathode active material, the 1^{st} CE values from the negative electrode and the positive electrode should be at least the same. Thus, in order to match the 1^{st} CE for a negative electrode containing a pure silicon active anode material with the 1^{st} CE for a positive electrode, the 1^{st} CE of the positive electrode would need to be lowered to 60%.

However, the matching of the 1^{st} CE from the negative and positive electrodes is also not the best practice for the cell's overall performance because the energy of the cell and the cycling lifetime of the cell is still limited. Due to the continuous volume change of the pure silicon anode active material during cycling, new SEI films are continuously formed with the CE already <100% at the negative electrode, which shortens the cycling lifetime. In order to overcome this issue, the 1^{st} CE of the positive electrode containing the pre-lthiated active cathode materials of the present disclosure are decreased, such that the positive electrode exhibits a 1^{st} Coulombic Efficiency (CE_{cathode}) that is less than the 1^{st} Coulombic Efficiency (CE_{anode}) of the negative electrode. In this case, the excess amount of lithium may be inserted into the active anode material during the 1^{st} charging step of the full cell. The extra amount of lithium could be released back to the electrolyte slowly during cycling to compensate the capacity loss from the continuous electrolyte decomposition that occurs at the surface of the active anode material, thereby, extending the cell's cycling lifetime.

The active anode and cathode materials may be formed into the desired shape for use in the negative and positive electrodes by mixing the active materials with one or more binders in various mass ratios. For example, the cathode active material comprising the pre-lithiated active cathode material with or without any additional active cathode material and/or additives may be mixed with a binder that includes, without limitation, polyvinylidene fluoride (PVDF), carboxymethylcellulose (cmc), polytetrafluoroethylene (PTFE), a polyacrylate, or a mixture or blend thereof. The anode active material comprising the mixture of carbon and silicon material may be mixed with a binder that includes, without limitation, carboxymethylcellulose (cmc), styrene butadiene rubber (SBR), a polyacrylic acid, a polyacrylate, a polyimide, or a mixture or blend thereof. The mass ratio of the active material (i.e., anode or cathode) to the binder may be in the range of 70:30 to 99.9:0.1; alternatively 70:30 to 99:1; alternatively, 80:20 to 99:1; alternatively, 80:20 to 95:5 with the larger ratio of active material to binder being used in applications requiring a higher energy density.

The current collector 7 in the positive 10 electrode may be made of any metal known in the art for use in an electrode of a lithium battery, such as for example, without limitation, aluminum, titanium, stainless steel, nickel, copper, carbon, zinc, gallium, silver, and combinations or alloys formed therefrom. The current collector 17 used in the negative electrode 20 may be a metallic foil that does not react with lithium ions. Several examples of such metallic foils may include, but not be limited to Cu, Fe, Ti, Ni, Mo, W, Zr, Mn, carbon, and lithium metal alloys. Alternatively, the metallic foil for the current collector 17 of the negative electrode 20 comprises Cu, Fe, Ni, or a mixture or alloy thereof. The current collectors 7, 17 used in one or more of the positive 10 and/or negative 20 electrodes may include at least one metal that is capable of forming an alloy with lithium.

Referring again to FIG. 1, an electrolyte 30 is positioned between and in contact with the negative electrode 20 and the positive electrode 10, such that the electrolyte 30 supports a reversible flow of lithium ions between the positive electrode 10 and the negative electrode 20. The separator 25 is configured to electrically isolate the positive electrode 10 from the negative electrode 20, while being permeable to the reversible flow of the lithium ions there through.

The electrolyte may be any non-flammable electrolyte. Alternatively, the electrolyte may be a liquid electrolyte comprising non-flammable organic solvents such as organic electrolytes with a high concentration of a lithium salt dissolved therein. The electrolyte may also be a polymeric or gel electrolyte such as, without limitation, polyethylene oxide (PEO), polyvinylidene fluoride (PVDF) or a mixture thereof with a lithium salt dissolved therein. The electrolyte may also be an inorganic electrolyte, including but not limited to, a ceramic oxide, glass, or a sulfide electrolyte.

Several specific examples of lithium salts, include, without limitation, lithium hexafluorophosphate (LiPF₆), lithium bis(oxalato)-borate (LiBOB), and lithium bis(trifluoro methane sulfonyl)imide (LiTFSi). These lithium salts may form a solution with an organic solvent, such as, for example, ethylene carbonate (EC), ethyl methyl carbonate (EMC), diethyl carbonate (DEC), dimethyl carbonate (DMC), propylene carbonate (PC), vinylene carbonate (VC), and fluoroethylene carbonate (FEC), to name a few. A specific example of an electrolyte is a 1 molar solution of LiPF₆ in a mixture of ethylene carbonate and diethyl carbonate (EC/DEC=50/50 vol.).

The separator 25 ensures that the active anode cathode material 15 and the active cathode material 5 do not touch and allows lithium ions to flow there through. The separator 25 may be a polymeric membrane comprising, without limitation, polyolefin based materials with semi-crystalline structure, such as polyethylene, polypropylene, and blends thereof, as well as micro-porous poly (methyl methacrylate)-grafted, siloxane grafted polyethylene, and polyvinylidene fluoride (PVDF) nanofiber webs.

The specific examples provided in this disclosure are given to illustrate various embodiments of the invention and should not be construed to limit the scope of the disclosure. The embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

In one example (EX-1), the 1^{st} Coulombic Efficiency (CE_{cathode}) of the positive electrode is about 1% less than the 1^{st} Coulombic Efficiency (CE_{anode}) of the negative electrode within their operated potential ranges. In a second example (EX-2), the 1^{st} Coulombic Efficiency (CE_{cathode}) of the positive electrode is about 5% less than the 1^{st} Coulombic Efficiency (CE_{anode}) of the negative electrode. In yet a third example (EX-3), the 1^{st} Coulombic Efficiency (CE_{cathode}) of the positive electrode is about 15% less than the 1^{st} Coulombic Efficiency (CE_{anode}) of the negative electrode. In each of these examples, a negative electrode comprising an active anode material having the same ratio of silicon material and carbon was utilized, while for the positive electrode different lithium amounts were introduced into LiNi_{0.8}Co_{0.1}Mn_{0.1}O₂ (NCM-811) during a pre-lithiation step, which accounts for the observable differences in the 1^{st} CE_{cathode}. In general, the negative electrode is cycled between 50 mV vs. Li/Li+ and 1.0 V vs. Li/Li+ at C/10 or C/20 to determine the 1^{st} cycle CE_{anode} and specific capacity. The positive electrode is cycled between 3.0 V vs. Li/Li+ and 4.35 V vs. Li/Li+ to determine the 1^{st} cycle CE_{cathode} and specific capacity. Various ranges of potentials may be used as necessary for the specific anode and cathode requirements.

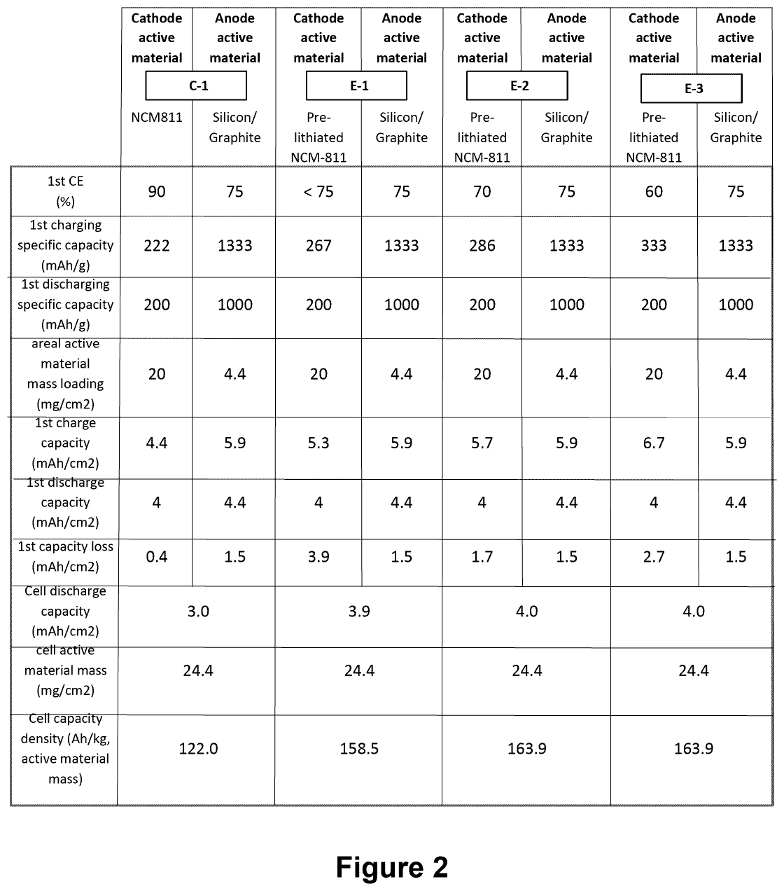

Referring now to FIG. 2, a table is provided that compares the performance of the three examples (EX-1, EX-2, & EX-3) against that of a comparative example (C-1). The comparative example (C-1) comprises the same active anode material in the negative electrode as the examples ((EX-1, EX-2, & EX-3), but uses conventional LiNi_{0.8}Co_{0.1}Mn_{0.1}O₂ (NCM-811) as the active cathode material in the positive electrode. The data demonstrates that increasing the 1^{st} CE_{cathode} of the positive electrode (i.e., 90% for C-1) results in only part of the cathode capacity being reversibly used (i.e., 3.0 mAh vs 4.0 mAh for the silicon/graphite anode). When the CE_{cathode} is slightly less than CE_{anode} (EX-1), the utilization of the cathode active material is close to the 4.0 mAh used by the silicon/graphite anode (i.e., 3.9 mAh vs 4.0 mAh) because of the 10% of excess of anode active material, which is designed to avoid lithium plating. Upon further lowering the 1^{st} CE_{cathode} (e.g. 70% for EX-2), the cell capacity is higher than for EX-1. Upon further reducing of the 1^{st} CE_{cathode} (see EX-3), the charging capacity from the cathode may be larger than the capacity from the active anode material (i.e., 5.9 mAh for active anode material vs. 6.7 mAh for active cathode material), which means that lithium plating will be expected if the cell is fully charged to its maximum voltage. In this case, when the cell is not charged to its full voltage, the cell capacity is reduced because the cathode active material is not fully charged. However, this issue may be mitigated by changing the charging protocol.

According to another aspect of the present disclosure, instead of charging the cell to its maximum voltage in one step, the protocol can be changed to a multiple step process. For example, the cell may be first charged to a lower cell voltage, and then cycled, followed by charging the cell to higher voltage. If necessary, steps of cycling the cell followed by charging the cell (i.e., a formation cycle) may be repeated until the cell reaches its maximum voltage. Thus, the cell may be configured to reach its maximum cell voltage in two or more formation cycles with the cell voltage increasing after each formation cycle or after at least one formation cycle.

A negative electrode comprising a silicon/carbon (e.g., silicon/graphite) electrode generally exhibits a gradual increase in Coulombic Efficiency (CE) with continual cycling of the cell. For example, the CE_{anode} for the silicon/carbon active anode material used in EX-1, EX-2, and EX-3, which has a 1^{st} CE_{anode} of 75%, gradually increases with continual cycling to a CE ranging from 75% to 80%, then from 85% to 90% and finally to about 97%. After the 1^{st} cycle, a significant amount of capacity irreversible loss at the anode active material may still occur. In this case, the excess of lithium stored will assist in compensating for the capacity loss, in particular, for the first few cycles until the cell's cycling performance stabilizes. Thus, according to the present disclosure, the 1^{st} charging (i.e., lithiating) capacity from the negative electrode is lower than the 1^{st} charging capacity from the positive electrode and the modified charging protocol is used to adapt the changes that occur. When necessary or desirable, an increase in the cell temperature may be used to accelerate the side reactions that occur at the surface of the anode active material.

According to yet another aspect of the present disclosure, one or more of the electrochemical cells may be combined to form a larger capacity battery or battery pack, such as a lithium-ion secondary battery used in an electric vehicle (EV). The one or more electrochemical cells may be incorporated in series, in parallel, or in a combination thereof in order to form the battery or battery pack. One skilled in the art will also appreciate that in addition to using the electrochemical cells in a lithium-ion secondary battery, the same principles may be used to encompass or encase one or more of these electrochemical cells into a housing for use in another application.

The housing may be constructed of any material known for such use in the art and be of any desired geometry required or desired for a specific application. For example, lithium-ion batteries generally are housed in three different main form factors or geometries, namely, cylindrical, prismatic, or soft pouch. The housing for a cylindrical battery may be made of aluminum, steel, or the like. Prismatic batteries generally comprise a housing that is rectangular shaped rather than cylindrical. Soft pouch housings may be made in a variety of shapes and sizes. These soft housings may be comprised of an aluminum foil pouch coated with a plastic on the inside, outside, or both. The soft housing may also be a polymeric-type encasing. The polymer composition used for the housing may be any known polymeric materials that are conventionally used in lithium-ion secondary batteries. One specific example, among many, include the use of a laminate pouch that comprises a polyolefin layer on the inside and a polyamide layer on the outside.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Those skilled-in-the-art, in light of the present disclosure, will appreciate that many changes can be made in the specific embodiments which are disclosed herein and still obtain alike or similar result without departing from or exceeding the spirit or scope of the disclosure. One skilled in the art will further understand that any properties reported herein represent properties that are routinely measured and can be obtained by multiple different methods. The methods described herein represent one such method and other methods may be utilized without exceeding the scope of the present disclosure.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A rechargeable electrochemical cell, the cell comprising:
a positive electrode comprising a current collector and a pre-lithiated active cathode material comprising one or more of Li₁₊ₓMn₂O₄, Li₁₊ₓNi_{0.5}Mn_{1.5}O₄, Li₁₊ₓNiO₂, Li₁₊ₓCoO₂, Li₁₊ₓNiₐCo_{b}Mn_{c}Al_{d}O₂, wherein x is in the range of 0.1 to 1.0; a+b+c+d=1;
a≥0.5; 0≤b≤0.3; 0≤c≤0.3; and 0≤d≤0.05;
a negative electrode comprising a current collector and an active anode material comprising a mixture of at least carbon and a silicon material; wherein the silicon material is silicon metal, SiO_{y}, or a mixture or composite thereof; wherein y ranges between 0≤y<2 and the carbon is graphite, soft carbon, or hard carbon;
wherein the positive electrode has a 1^{st} cycle Coulombic efficiency (CE_{cathode}) and the negative electrode has a 1^{st} cycle Coulombic Efficiency (CE_{anode}), such that CE_{cathode}<CE_{anode}.

2. The cell according to claim 1, wherein for the pre-lithiated active cathode material x is in the range of 0.3 to 0.6.

3. The cell according to claim 1, wherein the positive electrode further comprises an additional active cathode material, such that the mixture has a mass ratio of the pre-lithiated active cathode material to the additional active cathode material that ranges from 99.9:0.1 to about 1:99.

4. The cell according to claim 3, wherein the mass ratio of the pre-lithiated active cathode material to the additional active cathode material ranges from 99.9:0.1 to about 51:49.

5. The cell according to claim 1, wherein the active anode material has a mass ratio of silicon material to carbon that is in the range of about 10:90 to about 99.9:0.1.

6. The cell according to claim 5, wherein the mass ratio of silicon material to carbon is in the range of about 20:80 to about 40:60.

7. The cell according to claim 1, wherein the silicon material has an average particle size <1 micrometer (μm) or the silicon material has an average particle size between 1 μm and 4 μm or the silicon material has an average particle size >4 μm.

8. (canceled)

9. (canceled)

10. (canceled)

11. The cell according to claim 1, wherein the cell further comprises an electrolyte, the electrolyte being a non-flammable organic electrolyte, a polymeric or gel electrolyte, an inorganic electrolyte, or a combination thereof.

12. The cell according to claim 11, wherein the electrolyte is a non-flammable gel electrolyte.

13. The cell according to claim 1, wherein the cell has an areal reversible cathode capacity loading ≥3.0 mAh/cm².

14. The cell according to claim 13, wherein the areal reversible cathode capacity loading is ≥4.5 mAh/cm².

15. The cell according to claim 1, wherein the CE_{cathode} is less than the CE_{anode} by at least 1.0% up to 10%.

16. The cell according to claim 1, wherein the CE_{cathode} is less than the CE_{anode} by 10% or more.

17. The cell according to claim 1, wherein the cell is configured to reach its maximum cell voltage in two or more formation cycles with the cell voltage increasing after each formation cycle or after at least one formation cycle.

18. (canceled)

19. A battery pack for use in an electric vehicle, the battery pack comprising a plurality of cells according to claim 1, wherein the plurality of cells are a placed in series or in a parallel configuration in order to increase overall capacity.

20. A rechargeable electrochemical cell, the cell comprising:
a positive electrode that includes a current collector, and a pre-lithiated active cathode material according to the formula F-1 of Li₁₊ₓMn₂O₄, wherein x is in the range of 0.1 to 1.0;
a negative electrode comprising a current collector and an active anode material comprising a mixture of at least graphite and a silicon material; wherein the silicon material is silicon metal, SiO_{y}, or a mixture or composite thereof with y ranging between 0≤y<2; wherein the active anode material has a mass ratio of silicon material to graphite that is in the range of about 10:90 to about 99.9:0.1,
wherein the positive electrode has a 1^{st} cycle Coulombic efficiency (CE_{cathode}) and the negative electrode has a 1^{st} cycle Coulombic Efficiency (CE_{anode}), such that CE_{cathode}<CE_{anode} by an amount that falls in the range of one of the following groups: i) at least 1.0%, ii) up to 10%, or iii) 10% or more

21. The cell according to claim 20, wherein the positive electrode further comprises an additional active cathode material, such that the mixture has a mass ratio of the pre-lithiated active cathode material to the additional active cathode material that ranges from 99.9:0.1 to about 1:99.

22. The cell according to claim 20, wherein the silicon material has an average particle size that is in the range of one of the following groups: i)<1 micrometer (μm), ii) between 1 μm and 4 μm, or iii)>4 μm.

23. The cell according to claim 20, wherein the cell further comprises an electrolyte, the electrolyte being a non-flammable organic electrolyte, a polymeric or gel electrolyte, an inorganic electrolyte, or a combination thereof.

24. The cell according to claim 20, wherein one or more of the following are present:
the cell has an areal reversible cathode capacity loading ≥3.0 mAh/cm²; or
the cell is configured to reach its maximum cell voltage in two or more formation cycles with the cell voltage increasing after each formation cycle or after at least one formation cycle.

25. (canceled)
